(19) United States
(12) Patent Application Publication
(10) Pub. No.: US 2010/0028653 A1
(43) Pub. Date: Feb. 4, 2010

(54) DOUBLE-SIDED PRESSURE-SENSITIVE ADHESIVE SHEET, FOAM FIXING METHOD AND LAMINATE

(75) Inventors: Mutsumi KOBAYASHI, Osaka (JP); Kazuyuki YAGURA, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/533,035

(22) Filed: Jul. 31, 2009

(30) Foreign Application Priority Data
Aug. 4, 2008 (JP) 2008-200621

(51) Int. Cl. B32B 3/26; B32B 27/36; B32B 37/00

(52) U.S. Cl. 428/319.3; 428/354; 428/352; 156/60

(57) ABSTRACT

The present invention provides a double-sided pressure-sensitive adhesive sheet including: a plastic film substrate; a pressure-sensitive adhesive layer A provided on one side of the substrate; and a pressure-sensitive adhesive layer B provided on the other side of the substrate, in which the layer A is formed from an acrylic pressure-sensitive adhesive containing a crosslinking agent and a (meth)acrylic polymer composed of, as essential monomer components, a (meth)acrylic acid alkyl ester having an alkyl group having a carbon number of 2 to 6, a (meth)acrylic acid alkyl ester having an alkyl group having a carbon number of 7 to 12, a carboxyl group-containing monomer and a hydroxyl group-containing monomer and has a gel fraction of 5 to 40%, and the layer B is formed from an acrylic pressure-sensitive adhesive containing a crosslinking agent and a (meth)acrylic polymer composed of, as essential monomer components, a (meth)acrylic acid alkyl ester having an alkyl group having a carbon number of 2 to 12, a carboxyl group-containing monomer and a hydroxyl group-containing monomer and has a gel fraction of 30 to 60%.

### FIELD OF THE INVENTION

The present invention relates to a double-sided pressure-sensitive adhesive sheet. More specifically, the present invention relates to a double-sided pressure-sensitive adhesive sheet suitable for use in fixing a foam to an adherend and excellent in releasability. Also, the present invention relates to a foam fixing method using the double-sided pressure-sensitive adhesive sheet and a laminate obtained by laminating together a foam and an adherend through the double-sided pressure-sensitive adhesive sheet.

### BACKGROUND OF THE INVENTION

A double-sided pressure-sensitive adhesive sheet (including a double-sided pressure-sensitive adhesive tape) has been utilized as joining means assured of good workability and high reliability of adhesion in various industrial fields such as home electric appliances, automobiles and OA equipment. Recently, in view of resource saving, a recyclable component used in finished products is reused in many cases by dismantling the finished product after use. At this time, in the case of laminating the component to an adherend by using a double-sided pressure-sensitive adhesive sheet, the double-sided pressure-sensitive adhesive sheet laminated needs to be separated (released). The double-sided pressure-sensitive adhesive sheet released in this way is required to ensure that the pressure-sensitive adhesive does not remain on the adherend surface at the separation (adhesive residue preventing property) or the double-sided pressure-sensitive adhesive sheet is not ruptured during separation.

As regards the double-sided pressure-sensitive adhesive sheet used for applications where the adhesive sheet is released, various proposals have been heretofore made. For example, there is known, for preventing a rupture during separation, a double-sided pressure-sensitive adhesive tape where pressure-sensitive adhesive layers are provided on both surfaces of a nonwoven fabric substrate comprising Manila hemp as the main component and at least one of the pressure-sensitive adhesive layers is a water-soluble pressure-sensitive adhesive layer (see, Patent Document 1), or for improving the adhesive residue preventing property, a double-sided adhesive tape where pressure-sensitive adhesive layers are formed on both surfaces of a nonwoven substrate and interlaminar fracture is suppressed (see, Patent Document 2).

However, such a double-sided pressure-sensitive adhesive sheet using a nonwoven fabric substrate lacks elasticity and therefore, in use for fixing a narrow or long buffer material or film, positioning at the lamination is difficult or rupturing may occur when releasing the sheet, which significantly deteriorates the workability. In particular, with recent downsizing of the home electric appliances or OA equipment, the problem above is becoming more serious.

On the other hand, in the case of using a plastic film as the substrate of the double-sided pressure-sensitive adhesive sheet, although the problem of weak elasticity or rupturing of the substrate is improved, because of bad anchoring property of the pressure-sensitive adhesive to the substrate, an adhesive residue is produced and a work to remove the residue is required, still raising a problem of deterioration of workability.

Patent Document 1: JP-A-7-70527 (the term “JP-A” as used herein means an “unexamined published Japanese patent application”)

Patent Document 2 : JP-A-2003-342544

### SUMMARY OF THE INVENTION

An object of the present invention is to provide a double-sided pressure-sensitive adhesive sheet using a plastic film substrate ensuring good workability even when used for laminating together a narrow or long part, in which the double-sided pressure-sensitive adhesive sheet is excellent in the adhesiveness and at the same time, exerts excellent separability (releasability) without causing an adhesive residue at the separation of the sheet. Another object of the present invention is to provide a foam fixing method using the double-sided pressure-sensitive adhesive sheet and a laminate in which a foam is fixed.

As a result of intensive studies to attain these objects, the present inventors have found that when pressure-sensitive adhesive layers each of which is formed from an acrylic pressure-sensitive adhesive having a specific composition and controlled to a specific gel fraction are respectively provided on both sides of a plastic film substrate, an excellent double-sided pressure-sensitive adhesive sheet exhibiting good workability with firm elasticity even if used in a narrow or long form and ensuring excellent adhesiveness as well as less adhesive residue on an adherend at releasing can be obtained. The present invention has been accomplished based on this finding.

Namely, the present invention provides the following items.

1. A double-sided pressure-sensitive adhesive sheet comprising:

a plastic film substrate;

a pressure-sensitive adhesive layer A provided on one side of said substrate; and

a pressure-sensitive adhesive layer B provided on the other side of said substrate,

wherein the pressure-sensitive adhesive layer A is formed from an acrylic pressure-sensitive adhesive containing a crosslinking agent and a (meth)acrylic polymer composed of, as essential monomer components, a (meth)acrylic acid alkyl ester having an alkyl group having a carbon number of 2 to 6, a (meth)acrylic acid alkyl ester having an alkyl group having a carbon number of 7 to 12, a carboxyl group-containing monomer and a hydroxyl group-containing monomer, said layer A having a gel fraction of 5 to 40%, and

the pressure-sensitive adhesive layer B is formed from an acrylic pressure-sensitive adhesive containing a crosslinking agent and a (meth)acrylic polymer composed of, as essential monomer components, a (meth)acrylic acid alkyl ester having an alkyl group having a carbon number of 2 to 12, a carboxyl group-containing monomer and a hydroxyl group-containing monomer, said layer B having a gel fraction of 30 to 60%.

2. The double-sided pressure-sensitive adhesive sheet according to item 1, wherein in the acrylic pressure-sensitive adhesive forming said layer A, the total content of the (meth)acrylic acid alkyl ester having an alkyl group having a carbon number of 2 to 6 and the (meth)acrylic acid alkyl ester having an alkyl group having a carbon number of 7 to 12 is from 50 to 99 wt % based on all monomer components constituting the (meth)acrylic polymer, and

the content ratio between the (meth)acrylic acid alkyl ester having an alkyl group having a carbon number of 2 to 6 and the (meth)acrylic acid alkyl ester having an alkyl group having a carbon number of 7 to 12 is from 5/95 to 95/5 (by weight).

3. The double-sided pressure-sensitive adhesive sheet according to item 1, wherein the acrylic pressure-sensitive adhesive forming said layer A contains from 1 to 5 parts by weight of an isocyanate-based crosslinking agent per 100 parts by weight of the (meth)acrylic polymer.

4. The double-sided pressure-sensitive adhesive sheet according to item 1, wherein in the acrylic pressure-sensitive adhesive forming said layer B, the content of the (meth)acrylic acid alkyl ester having an alkyl group having a carbon number of 2 to 12 is from 50 to 99 wt % based on all monomer components constituting the (meth)acrylic polymer.

5. The double-sided pressure-sensitive adhesive sheet according to item 1, wherein the acrylic pressure-sensitive adhesive forming said layer B contains from 3 to 8 parts by weight of an isocyanate-based crosslinking agent per 100 parts by weight of the (meth)acrylic polymer.

6. The double-sided pressure-sensitive adhesive sheet according to item 1, wherein said layer A has a storage modulus at 23° C. of from 0.1×10⁵ to 1.0×10⁵ Pa and said layer B has a storage modulus at 23° C. of from 1.0×10⁵ to 7.0×10⁵ Pa, as measured by a dynamic viscoelasticity test.

7. The double-sided pressure-sensitive adhesive sheet according to item 1, wherein said layer A has a breaking elongation of from 2,000 to 4,000% and said layer B has a breaking elongation of from 800 to 2,500%, as measured by a tensile test (23° C., 50% RH).

8. The double-sided pressure-sensitive adhesive sheet according to item 1, wherein the acrylic pressure-sensitive adhesive forming said layer A further contains 1 to 60 parts by weight of a rosin-based tackifying resin per 100 parts by weight of the (meth)acrylic polymer.

9. The double-sided pressure-sensitive adhesive sheet according to item 1, wherein the acrylic pressure-sensitive adhesive forming said layer B further contains 1 to 60 parts by weight of a terpene phenolic tackifying resin per 100 parts by weight of the (meth)acrylic polymer.

10. The double-sided pressure-sensitive adhesive sheet according to item 1, wherein the gel fraction of said layer B is larger than the gel fraction of said layer A.

11. The double-sided pressure-sensitive adhesive sheet according to item 1, which is a double-sided pressure-sensitive adhesive sheet used for fixing a foam to an adherend and is releasable from the adherend.

12. A method of fixing a foam, said method comprising laminating a foam to the pressure-sensitive adhesive surface of said layer A of the double-sided pressure-sensitive adhesive sheet according to item 1 and laminating an adherend to the pressure-sensitive adhesive surface of said layer B of the double-sided pressure-sensitive adhesive sheet.

13. A laminate obtained by laminating together a foam and an adherend through the double-sided pressure-sensitive adhesive sheet according to item 1.

The double-sided pressure-sensitive adhesive sheet of the present invention has the above-described constructions and therefore, even when used for fixing a narrow or long part, is assured of good lamination workability with firm elasticity. Also, the adhesiveness to an adherend is excellent. Furthermore, since separation of the sheet involves neither rupturing of the substrate nor adhesive residue, the releasability is also excellent.

### BRIEF DESCRIPTION OF THE DRAWING

FIG. 1 is an illustrative view for explaining the manner of determining the “adhesive force (180° peel, to foam)” from a releasing chart.

### DESCRIPTION OF REFERENCE NUMERALS AND SIGNS

X: Releasing chart

A1 to A5: Crests of ridge portions

B1 to B6: Crests of trough portions

### DETAILED DESCRIPTION OF THE INVENTION

Embodiments of the present invention are described in detail below.

The double-sided pressure-sensitive adhesive sheet of the present invention has a pressure-sensitive adhesive layer on each side of a plastic film substrate and has a laminated structure including at least three layers. In the following, one pressure-sensitive adhesive layer is referred to as the layer A, and the other pressure-sensitive adhesive layer is referred to as the layer B. Also, The double-sided pressure-sensitive adhesive sheet of the present invention may have other layers (such as intermediate layer or undercoat layer) within the range not impairing the effect of the present invention. Furthermore, the plastic film substrate and the pressure-sensitive adhesive layers may be stacked directly or may be stacked through another layer such as intermediate layer. The “double-sided pressure-sensitive adhesive sheet” as used in the present invention includes a tape form, that is, a “double-sided pressure-sensitive adhesive tape”.

### Plastic Film Substrate

The plastic film substrate used in the double-sided pressure-sensitive adhesive sheet of the present invention is a substrate supporting a pressure-sensitive adhesive layer and plays a role in enhancing the processability and handleability (handling property) of the double-sided pressure-sensitive adhesive sheet. As for the plastic film, those generally employed as a support of a pressure-sensitive adhesive sheet may be used, and examples thereof include resin films composed of a polyester-based resin such as polyethylene terephthalate (PET), polybutylene terephthalate (PBT) and polyethylene naphthalate (PEN), an olefin-based resin such as polyethylene (PE) and polypropylene (PP), a polyvinyl chloride-based resin, polyvinyl alcohol-based resin, an acrylic resin, a vinyl acetate-based resin, an amide-based resin, a polyimide-based resin, polyether ether ketone, polyphenylene sulfide and the like. Among these, in view of adherence to the pressure-sensitive adhesive layer, a strongly adhesive substrate composed of a high-polarity polymer such as polyester-based film is preferred, and a polyethylene terephthalate (PET) film is more preferred. Incidentally, the plastic film substrate may have a single-layer construction or may have a construction composed of a plurality of layers.

For enhancing the adherence to the pressure-sensitive adhesive layer, the surface of the plastic film substrate may be subjected, if desired, to a conventional surface treatment, for example, an oxidation treatment by a chemical or physical method, such as chromic acid treatment, ozone exposure, flame exposure, high-voltage electric shock exposure and ionization radiation treatment, or may be subjected to a coating treatment or the like with a primer.

The thickness of the plastic film substrate is not particularly limited but in view of lamination workability, is preferably 38 μm or more, more preferably 75 μm or more, and from the standpoint of processability, is preferably 210 μm or less, more preferably 188 μm or less.

### Pressure-Sensitive Adhesive Layer

The pressure-sensitive adhesive layer in the double-sided pressure-sensitive adhesive sheet of the present invention is formed from an acrylic pressure-sensitive adhesive containing a (meth)acrylic polymer as the main component and further containing a crosslinking agent. In the following, the “(meth)acrylic polymer” may be sometimes simply referred to as an “acrylic polymer”. Such a pressure-sensitive adhesive can be produced by adding, if desired, various additives, to the above-described acrylic polymer and crosslinking agent. The content of the acrylic polymer as the main component is preferably 50 wt %, more preferably 60 wt % or more, still more preferably 65 wt % or more, based on the total weight (as solid content) of the pressure-sensitive adhesive. The “(meth)acryl” as used herein means “acryl” and/or “methacryl”.

### (Layer A)

The acrylic polymer (hereinafter sometimes referred to as an “acrylic polymer (A)”) for use in the acrylic pressure-sensitive adhesive forming one pressure-sensitive adhesive layer (layer A) out of the pressure-sensitive adhesive layers in the double-sided pressure-sensitive adhesive sheet of the present invention is composed using, as essential monomer components, a (meth)acrylic acid alkyl ester having an alkyl group having a carbon number of 2 to 6, a (meth)acrylic acid alkyl ester having an alkyl group having a carbon number of 7 to 12, a carboxyl group-containing monomer and a hydroxyl group-containing monomer. If desired, other ethylenically unsaturated monomers may be used as a copolymerization component (copolymerization monomer). As for each of the (meth)acrylic acid alkyl ester, carboxyl group-containing monomer, hydroxyl group-containing monomer and other ethylenically unsaturated monomers, one kind may be used alone or two or more kinds may be used in combination. The “(meth)acrylic acid alkyl ester” as used herein means “acrylic acid alkyl ester and/or methacrylic acid alkyl ester”, and the same applies to others. Also, the “alkyl group” of the (meth)acrylic acid alkyl ester means a “linear or branched alkyl group”.

Examples of the (meth)acrylic acid alkyl ester having an alkyl group having a carbon number of 2 to 6 include ethyl(meth)acrylate, propyl(meth)acrylate, isopropyl(meth)acrylate, n-butyl(meth)acrylate, isobutyl(meth)acrylate, sec-butyl(meth)acrylate, tert-butyl(meth)acrylate, pentyl(meth)acrylate, isopentyl(meth)acrylate, neopentyl(meth)acrylate and hexyl(meth)acrylate. Among these, n-butyl acrylate is preferred.

Examples of the (meth)acrylic acid alkyl ester having an alkyl group having a carbon number of 7 to 12 include heptyl(meth)acrylate, octyl(meth)acrylate, isooctyl(meth)acrylate, 2-ethylhexyl(meth)acrylate, nonyl(meth)acrylate, isononyl(meth)acrylate, decyl(meth)acrylate, isodecyl(meth)acrylate, undecyl(meth)acrylate and dodecyl(meth)acrylate. Among these, 2-ethylhexyl acrylate is preferred.

Examples of the carboxyl group-containing monomer include a carboxyl group-containing monomer such as (meth)acrylic acid, itaconic acid, maleic acid, fumaric acid and isocrotonic acid, and an acid anhydride thereof (such as maleic anhydride and itaconic anhydride). Among these, acrylic acid is preferred.

Examples of the hydroxyl group-containing monomer include a hydroxyalkyl(meth)acrylate such as 2-hydroxyethyl(meth)acrylate, 2-hydroxypropyl(meth)acrylate, 2-hydroxybutyl(meth)acrylate and 4-hydroxybutyl(meth)acrylate, a vinyl alcohol, and an allyl alcohol. Among these, 2-hydroxyethyl acrylate and 4-hydroxybutyl acrylate are preferred.

Other ethylenically unsaturated monomers used as a copolymerization monomer may be used, for example, for introducing a crosslinking point into the acrylic polymer (A) or controlling the cohesive force of the acrylic polymer (A). Examples of the copolymerization monomer above (other ethylenically unsaturated monomers) include an amide-based monomer such as (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide and N-butoxymethyl(meth)acrylamide; an amino group-containing monomer such as aminoethyl(meth)acrylate, N,N-dimethylaminoethyl(meth)acrylate and tert-butylaminoethyl(meth)acrylate; an epoxy group-containing monomer such as glycidyl(meth)acrylate and methylglycidyl(meth)acrylate; a cyano group-containing monomer such as acrylonitrile and methacrylonitrile; and a monomer having a nitrogen atom-containing ring, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam and N-(meth)acryloylmorpholine. There may also be used, for example, a vinyl ester-based monomer such as vinyl acetate and vinyl propionate; a styrene-based monomer such as styrene, substituted styrene (e.g., α-methylstyrene) and vinyltoluene; an olefin-based monomer such as ethylene, propylene, isoprene, butadiene and isobutylene; vinyl chloride and vinylidene chloride; an isocyanate group-containing monomer such as 2-(meth)acryloyloxyethyl isocyanate; an alkoxy group-containing monomer such as methoxyethyl(meth)acrylate and ethoxyethyl(meth)acrylate; a cycloalkyl(meth)acrylate such as cyclohexyl(meth)acrylate; a vinyl ether-based monomer such as methyl vinyl ether and ethyl vinyl ether; and a polyfunctional monomer such as 1,6-hexanediol di(meth)acrylate, butanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, glycerin di(meth)acrylate, epoxy acrylate, polyester acrylate, urethane acrylate and divinylbenzene.

The total content of the (meth)acrylic acid alkyl ester having an alkyl group having a carbon number of 2 to 6 and the (meth)acrylic acid alkyl ester having an alkyl group having a carbon number of 7 to 12 {(content of the (meth)acrylic acid alkyl ester having an alkyl group having a carbon number of 2 to 6)+(content of the (meth)acrylic acid alkyl ester having an alkyl group having a carbon number of 7 to 12)} is preferably 50 wt % or more, more preferably 80 wt % or more, still more preferably 90 wt % or more, based on the entire amount of monomer components constituting the acrylic polymer (A). The upper limit of the total content is not particularly limited but is preferably 99 wt % or less, more preferably 98 wt % or less, more preferably 97 wt % or less. The (meth)acrylic acid alkyl ester having an alkyl group having a carbon number of 2 to 6 and the (meth)acrylic acid alkyl ester having an alkyl group having a carbon number of 7 to 12 are main monomer components assuming the pressure-sensitive adhesive characteristics of the acrylic polymer (A) and therefore, if their total content is less than 50 wt %, the characteristics (e.g., pressure-sensitive adhesiveness) as an acrylic polymer may be hardly brought out.

The content ratio (by weight) between the (meth)acrylic acid alkyl ester having an alkyl group having a carbon number of 2 to 6 and the (meth)acrylic acid alkyl ester having an alkyl group having a carbon number of 7 to 12 {(content of the (meth)acrylic acid alkyl ester having an alkyl group having a carbon number of 2 to 6)/(content of the (meth)acrylic acid alkyl ester having an alkyl group having a carbon number of 7 to 12)} is preferably from 5/95 to 95/5, more preferably from 50/50 to 90/10. The layer A preferably exerts good adhesive force particularly to a rough surface of a foam or the like and for this purpose, the acrylic polymer (A) preferably has a certain degree of flexibility (low Young's modulus and large breaking elongation). The (meth)acrylic acid alkyl ester having an alkyl group having a carbon number of 7 to 12 plays a role in imparting flexibility to the acrylic polymer (A), and the (meth)acrylic acid alkyl ester having an alkyl group having a carbon number of 2 to 6 plays a role in imparting a certain degree of hardness to the polymer and maintaining the processability. In the case where the content ratio is in the range above, both flexibility and processability of the acrylic polymer (A) can be satisfied and this is preferred. If the content of the (meth)acrylic acid alkyl ester having an alkyl group having a carbon number of 7 to 12 is less than the range above, flexibility of the acrylic polymer (A) may be reduced to cause deterioration of the adhesiveness to a rough surface, whereas if the content of the (meth)acrylic acid alkyl ester having an alkyl group having a carbon number of 7 to 12 exceeds the above-described range, the processability may be reduced to deteriorate the punching processability of the double-sided pressure-sensitive adhesive sheet.

Out of the monomer components constituting the acrylic polymer (A), from the standpoint of enhancing the adhesive force and balancing the hardness with the polarity, the content of the carboxyl group-containing monomer (particularly, an acrylic acid) is preferably from 1 to 15 parts by weight, more preferably from 1 to 10 parts by weight, still more preferably from 1 to 5 parts by weight, per 100 parts by weight of the total content of the (meth)acrylic acid alkyl ester having an alkyl group having a carbon number of 2 to 6 and the (meth)acrylic acid alkyl ester having an alkyl group having a carbon number of 7 to 12. If the content of the carboxyl group-containing monomer is less than 1 part by weight, sufficient adhesive force may not be obtained, whereas if it exceeds 15 parts by weight, the characteristics may not be balanced.

Out of the monomer components constituting the acrylic polymer (A), from the standpoint of accelerating the crosslinking, the content of the hydroxyl group-containing monomer is preferably from 0.01 to 0.5 parts by weight, more preferably from 0.01 to 0.2 parts by weight, still more preferably from 0.01 to 0. 1 parts by weight, per 100 parts by weight of the total content of the (meth)acrylic acid alkyl ester having an alkyl group having a carbon number of 2 to 6 and the (meth)acrylic acid alkyl ester having an alkyl group having a carbon number of 7 to 12. If the content of the hydroxyl group-containing monomer is less than 0.01 parts by weight, the effect of accelerating the crosslinking may not be obtained, whereas if it exceeds 0.5 parts by weight, gelling proceeds rapidly and a problem may arise in the coatability.

The acrylic polymer (A) can be prepared by a known or conventional polymerization method. Examples of the polymerization method include a solution polymerization method, an emulsion polymerization method, a bulk polymerization method, and a polymerization method by ultraviolet irradiation. Among these, a solution polymerization method is preferred in view of cost and mass production. At the polymerization, proper components according to the polymerization method, such as polymerization initiator, chain transfer agent, emulsifier and solvent, may be appropriately selected from known or conventional compounds and used.

Polymerization initiator, chain transfer agent and the like used at the polymerization of the acrylic polymer (A) are not particularly limited and may be appropriately selected from known or conventional compounds. More specifically, preferred examples of the polymerization initiator include an oil-soluble polymerization initiator such as an azo-based polymerization initiator, e.g., 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methylpropionate); and a peroxide-based polymerization initiator, e.g., benzoyl peroxide, tert-butyl hydroperoxide, di-tert-butyl peroxide, tert-butyl peroxybenzoate, dicumyl peroxide, 1,1-bis(tert-butylperoxy)3,3,5-trimethylcyclohexane, 1,1-bis(tert-butylperoxy)cyclododecane. One of these polymerization initiators may be used alone, or two or more thereof may be used in combination. The amount of the polymerization initiator used may be a normal amount and can be selected, for example, in the range of approximately from 0.01 to 1 part by weight per 100 parts by weight of all monomer components constituting the acrylic polymer (A).

As for the solvent used at the time of polymerizing the acrylic polymer (A) by solution polymerization, a known or conventional organic solvent or the like may be used, and examples thereof include an ester-based solvent such as ethyl acetate and methyl acetate; a ketone-based solvent such as acetone and methyl ethyl ketone; an alcohol-based solvent such as methanol, ethanol and butanol; a hydrocarbon-based solvent such as cyclohexane, hexane and heptane; and an aromatic solvent such as toluene and xylene. One of these organic solvents may be used alone, or two or more thereof may be mixed and used.

The crosslinking agent used in the acrylic pressure-sensitive adhesive forming the layer A of the double-sided pressure-sensitive adhesive sheet of the present invention plays a role, for example, in controlling the gel fraction (proportion of the solvent-insoluble portion) of the pressure-sensitive adhesive layer. Examples of the crosslinking agent include an isocyanate-based crosslinking agent, an epoxy-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, an oxazoline-based crosslinking agent, an azilidine-based crosslinking agent and an amine-based crosslinking agent. Among these, an isocyanate-based crosslinking agent is preferred. One of these crosslinking agents may be used alone, or two or more thereof may be used in combination.

Examples of the isocyanate-based crosslinking agent include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. Other examples include a trimethylolpropane/tolylene diisocyanate trimer adduct (“Coronate L”, trade name, produced by Nippon Polyurethane Industry Co., Ltd.) and a trimethylolpropane/hexamethylene diisocyanate trimer adduct (“Coronate HL”, trade name, produced by Nippon Polyurethane Industry Co., Ltd.).

Examples of the epoxy-based crosslinking agent include N,N,N′,N′-tetraglycidyl-m-xylenediamine, diglycidylaniline, 1,3-bis(N,N-glycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, diglycidyl adipate, diglycidyl o-phthalate, triglycidyl-tris(2-hydroxyethyl)isocyanurate, resorcin diglycidyl ether, bisphenol-S-diglycidyl ether, and an epoxy-based resin having two or more epoxy groups within the molecule.

The content of the crosslinking agent (particularly, an isocyanate-based crosslinking agent) in the acrylic pressure-sensitive adhesive forming the layer A is preferably from 1 to 5 parts by weight, more preferably from 1 to 4 parts by weight, still more preferably from 2 to 3 parts by weight, per 100 parts by weight of the acrylic polymer (A). If the content of the crosslinking agent is less than 1 part by weight, the pressure-sensitive adhesive characteristics and processability may be deteriorated, whereas if it exceeds 5 parts by weight, the gel fraction of the layer A becomes excessively high and the pressure-sensitive adhesiveness particularly to a rough surface of a foam or the like may be reduced.

In the acrylic pressure-sensitive adhesive forming the layer A of the double-sided pressure-sensitive adhesive sheet of the present invention, from the standpoint of enhancing the pressure-sensitive adhesiveness, a tackifying resin (tackifier) is preferably added. Examples of the tackifying resin include a terpene-based tackifying resin, a phenolic tackifying resin, a rosin-based tackifying resin and a petroleum-based tackifying resin. Among these, a rosin-based tackifying resin is preferred. One of these tackifying resins may be used alone, or two or more thereof may be used in combination.

Examples of the terpene-based tackifying resin include a terpene-base resin such as α-pinene polymer, β-pinene polymer and diterpene polymer, and a modified terpene-based resin (e.g., terpene phenolic resin, styrene-modified terpene-based resin, aromatic-modified terpene-based resin, hydrogenated terpene-based resin) obtained by modifying (for example, phenol modification, aromatic modification, hydrogenation modification or hydrocarbon modification) the terpene-based resin above.

Examples of the phenolic tackifying resin include a condensate (e.g., alkylphenolic resin, xylene formaldehyde-based resin) of various phenols (e.g., phenol, m-cresol, 3,5-xylenol, p-alkylphenol, resorcin) with formaldehyde, a resol obtained by addition-reacting the phenols above with formaldehyde in the presence of an alkali catalyst, a novolak obtained by condensation-reacting the phenols above with formaldehyde in the presence of an acid catalyst, and a rosin-modified phenol resin obtained by adding and thermally polymerizing phenol and rosins (for example, an unmodified rosin, a modified rosin or various rosin derivatives) in the presence of an acid catalyst.

Examples of the rosin-based tackifying resin include an unmodified rosin (natural rosin) such as gum rosin, wood rosin and tall oil rosin, a modified rosin (e.g., hydrogenated rosin, disproportionated rosin, polymerized rosin, other chemically modified rosins) obtained by modifying the unmodified rosin above through hydrogenation, disproportionation, polymerization or the like, and various rosin derivatives. Examples of the rosin derivative include rosin esters such as a rosin ester compound obtained by esterifying an unmodified rosin with alcohols, and a modified rosin ester compound obtained by esterifying a modified rosin (e.g., hydrogenated rosin, disproportionated rosin, polymerized rosin) with alcohols; unsaturated fatty acid-modified rosins obtained by modifying an unmodified rosin or a modified rosin (e.g., hydrogenated rosin, disproportionated rosin, polymerized rosin) with an unsaturated fatty acid; unsaturated fatty acid-modified rosin esters obtained by modifying rosin esters with an unsaturated fatty acid; rosin alcohols obtained by reducing the carboxyl group in unmodified rosins, modified rosins (e.g., hydrogenated rosin, disproportionated rosin, polymerized rosin), unsaturated fatty acid-modified rosins or unsaturated fatty acid-modified rosin esters; and metal salts of rosins (particularly, rosin esters) such as unmodified rosin, modified rosin and various rosin derivatives.

Examples of the petroleum-based tackifying resin which can be used include a known petroleum resin such as aromatic petroleum resin, aliphatic petroleum resin, alicyclic petroleum resin (aliphatic cyclic petroleum resin), aliphatic•aromatic petroleum resin, aliphatic•alicyclic petroleum resin, hydrogenated petroleum resin, coumarone-based resin and coumarone-indene-based resin. More specifically, examples of the aromatic petroleum resin include a polymer using only one species or two or more species of vinyl group-containing aromatic hydrocarbons having a carbon number of 8 to 10 (e.g., styrene, o-vinyltoluene, m-vinyltoluene, p-vinyltoluene, α-methylstyrene, β-methylstyrene, indene, methylindene). As for the aromatic petroleum resin, an aromatic petroleum resin (so-called “C9 petroleum resin”) obtained from a fraction (so-called “C9 petroleum fraction”) such as vinyl toluene and indene may be suitably used. Examples of the aliphatic petroleum resin include a polymer using only one species or two or more species of olefins or dienes having a carbon number of 4 to 5 (for example, an olefin such as butene-1, isobutylene and pentene 1; and a diene such as butadiene and piperylene (1,3-pentadiene) and isoprene). As for the aliphatic petroleum resin, an aliphatic petroleum resin (so-called “C4 petroleum resin” or “C5 petroleum resin”) obtained from a fraction (so-called “C4 petroleum fraction” or “C5 petroleum fraction”) such as butadiene, piperylene and isoprene may be suitably used. Examples of the alicyclic petroleum resin include an alicyclic hydrocarbon-based resin obtained by cyclizing and dimerizing an aliphatic petroleum resin (so-called “C4 petroleum resin” or “C5 petroleum resin”) and then polymerizing the dimer, a polymer of cyclic diene compound (e.g., cyclopentadiene, dicyclopentadiene, ethylidene norbornene, dipentene, ethylidene bicycloheptene, vinylcycloheptene, tetrahydroindene, vinylcyclohexene, limonene), a hydrogenation product thereof, and an alicyclic hydrocarbon-based resin obtained by hydrogenating the aromatic ring in the above-described aromatic hydrocarbon resin or the aliphatic•aromatic petroleum resin below. Examples of the aliphatic•aromatic petroleum resin include a styrene-olefin-based copolymer. As for the aliphatic•aromatic petroleum resin, a so-called “C5/C9 copolymer petroleum resin” or the like may be used.

The tackifying resin may be a commercial product and, for example, “PENSEL D125”, trade name, produced by Arakawa Chemical Industries, Ltd. or “SUMILITERESIN PR-12603”, trade name, produced by Sumitomo Bakelite Co., Ltd. may be used.

The amount of the tackifying resin added is preferably from 1 to 60 parts by weight, more preferably from 20 to 40 parts by weight, per 100 parts by weight of the acrylic polymer (A). If the amount added is less than 1 part by weight, a sufficient pressure-sensitive adhesive force may not be brought out, whereas if it exceeds 60 parts by weight, the adhesiveness may be deteriorated.

In addition to the above-mentioned components, the acrylic pressure-sensitive adhesive forming the layer A may contain, if desired, known additives such as antiaging agent, filler, colorant (e.g., pigment or dye), ultraviolet absorber, antioxidant, plasticizer, softener, surfactant and antistatic agent, within the range not impairing the characteristics of the present invention.

The method for forming the layer A in the double-sided pressure-sensitive adhesive sheet of the present invention is not particularly limited and may be appropriately selected from known methods for forming a pressure-sensitive adhesive layer (the same applies to the layer B). Specific examples of the method include a method (direct method) where the acrylic pressure-sensitive adhesive above (or an acrylic pressure-sensitive adhesive solution) is coated and dried or cured on the plastic film substrate surface to a thickness giving a predetermined thickness after drying, and a method (transfer method) where the acrylic pressure-sensitive adhesive (or an acrylic pressure-sensitive adhesive solution) is coated and if desired, dried or cured on an appropriate release liner to form a pressure-sensitive adhesive layer and the pressure-sensitive adhesive layer is transferred (moved and fixed) onto a plastic film substrate. Among these, from the standpoint of enhancing the anchoring property to the substrate, a direct method is preferred. Incidentally, at the coating of the acrylic pressure-sensitive adhesive (or an acrylic pressure-sensitive adhesive solution), a conventionally employed coater (e.g., gravure coater, reverse roll coater, kiss roll coater, dip roll coater, bar coater, knife coater, spray coater) may be used.

The thickness of the layer A in the double-sided pressure-sensitive adhesive sheet of the present invention is not particularly limited but is preferably from 40 to 100 μm, more preferably from 45 to 90 μm, still more preferably from 50 to 80 μm. If the thickness of the layer A is less than 40 μm, the adhesiveness to a rough surface may not be sufficiently brought out, whereas if it exceeds 100 μm, the processability or coatability may be deteriorated. Incidentally, the layer A may have either a single-layer construction or a multilayer construction.

The layer A in the double-sided pressure-sensitive adhesive sheet of the present invention has a gel fraction of 5 to 40% (wt %), preferably from 10 to 40%, still more preferably from 15 to 35%. If the gel fraction is less than 5%, the cohesive force of the layer A is reduced to readily cause a cohesion failure and, for example, reduction of the adhesiveness disadvantageously occurs, whereas if it exceeds 40%, the layer A becomes hard to reduce the adhesiveness to a rough surface of a foam or the like and this is not preferred. The gel fraction above can be controlled, for example, by the monomer composition of the acrylic polymer (A) or the kind or content of the crosslinking agent.

The gel fraction (proportion of the solvent-insoluble portion) is a value calculated by the following “Measuring Method for Gel Fraction”.

### (Measuring Method for Gel Fraction)

About 0. 1 g of the pressure-sensitive adhesive is sampled from the pressure-sensitive adhesive layer (after crosslinking) of the double-sided pressure-sensitive adhesive sheet, wrapped with a porous tetrafluoroethylene sheet (“NTF1122”, trade name, produced by Nitto Denko Corporation) having an average pore size of 0.2 μm, tied up with a kite string and at this time, measured for the weight, and the weight measured is designated as the weight before impregnation. Incidentally, the weight before impregnation is the total weight of the pressure-sensitive adhesive layer (pressure-sensitive adhesive), the tetrafluoroethylene sheet and the kite string. The total weight of the tetrafluoroethylene sheet and the kite string is also measured and this weight is designated as the wrapper weight.

Subsequently, the pressure-sensitive adhesive layer wrapped with a tetrafluoroethylene sheet and tied up with a kite string (hereinafter referred to as the “sample”) is put in a 50 ml-volume vessel filled with ethyl acetate, and allowed to stand still at room temperature for 1 week (7 days). The sample (after ethyl acetate treatment) is then taken out from the vessel, transferred to an aluminum-made cup, dried in a dryer at 130° C. for 2 hours to remove the ethyl acetate, and measured for the weight, and the weight measured is designated as the weight after impregnation.

The gel fraction is calculated according to the following formula:

Gel fraction (wt %)=(A−B)/(C−B)×100 (1)

(In formula (1), A is the weight after impregnation, B is the wrapper weight, and C is the weight before impregnation.)

The storage modulus (G′) at 23° C. of the layer A (resin for the layer A) in the double-sided pressure-sensitive adhesive sheet of the present invention is preferably from 0.1×10⁵ to 1.0×10⁵ Pa, more preferably from 0.3×10⁵ to 1.0×10⁵ Pa, still more preferably from 0.5×10⁵ to 0.9×10⁵ Pa. If the storage modulus is less than 0.1×10⁵ Pa, the cohesive force of the layer A is reduced and a cohesion failure readily occurs to deteriorate the adhesiveness, whereas if it exceeds 1.0×10⁵ Pa, the layer A is hard and the adhesiveness to a rough surface of a foam or the like may be deteriorated. The storage modulus above can be controlled, for example, by the monomer composition of the acrylic polymer (A), the kind or content of the crosslinking agent, or the gel fraction. The storage modulus can be determined by a dynamic viscoelasticity measurement. For example, a layer A resin (after crosslinking) having a thickness of about 1.5 mm is prepared as a sample, and the sample is measured using a dynamic viscoelasticity measuring apparatus, “RDS-II”, produced by Rheometrics Co., Ltd. with a parallel plate of 7.9 mm in diameter as a jig under the conditions of a frequency of 1 Hz, a temperature range of −70 to 200° C. and a temperature rising rate of 5° C./min.

The peak temperature (temperature at a maximum value of tan δ) of the loss tangent (tan δ) determined by the same dynamic viscoelasticity measurement as above of the layer A (resin for the layer A) in the double-sided pressure-sensitive adhesive sheet of the present invention is preferably from −25 to 0° C., more preferably from −20 to −5° C., from the standpoint of enhancing the adhesiveness to a rough surface by utilizing flexibility of the layer A. The peak temperature of tan δ can be controlled, for example, by the monomer composition of the acrylic polymer (A), the kind or content of the crosslinking agent, or the tackifier.

The breaking elongation at 23° C. and 50% RH of the layer A (resin for the layer A) in the double-sided pressure-sensitive adhesive sheet of the present invention is preferably from 2,000 to 4,000%, more preferably from 2,200 to 3,500%. If the breaking elongation is less than 2,000%, the layer A is hard and the adhesiveness to a rough surface of a foam or the like may be deteriorated, whereas if it exceeds 4,000%, the cohesive force of the layer A is reduced to readily cause a cohesion failure and the adhesiveness is sometimes deteriorated. The breaking elongation can be controlled, for example, by the monomer composition of the acrylic polymer (A), the kind or content of the crosslinking agent, or the gel fraction. The breaking elongation can be determined by a tensile test. For example, the resin for the layer A (after crosslinking) is formed into a string-like sample having a cross-sectional area of 2 mm², and the sample is measured under the condition of a chuck-to-chuck distance of 10 mm and a tensile speed of 50 mm/min.

### (Layer B)

The acrylic polymer (hereinafter sometimes referred to as an “acrylic polymer (B)”) used for the acrylic pressure-sensitive adhesive forming the other pressure-sensitive adhesive layer (layer B) out of the pressure-sensitive adhesive layers in the double-sided pressure-sensitive adhesive sheet of the present invention is composed using, as essential monomer components, a (meth)acrylic acid alkyl ester having an alkyl group having a carbon number of 2 to 12, a carboxyl group-containing monomer and a hydroxyl group-containing monomer. If desired, other ethylenically unsaturated monomers may be used as a copolymerization component (copolymerization monomer). As for each of the (meth)acrylic acid alkyl ester, carboxyl group-containing monomer, hydroxyl group-containing monomer and other ethylenically unsaturated monomers, one kind may be used alone or two or more kinds may be used in combination. The “alkyl group” of the (meth)acrylic acid alkyl ester means a “linear or branched alkyl group”.

As regards the (meth)acrylic acid alkyl ester having an alkyl group having a carbon number of 2 to 12, those described above as examples of the (meth)acrylic acid alkyl ester having an alkyl group having a carbon number of 2 to 6 and the (meth)acrylic acid alkyl ester having an alkyl group having a carbon number of 7 to 12 both constituting the acrylic polymer (A) may be used. Above all, n-butyl acrylate is preferred.

In the present invention, the (meth)acrylic acid alkyl ester needs to be different between the layer A and the layer B. The term “different” as used herein is defined as the layer A and the layer B differing in at least either the composition of the (meth)acrylic acid alkyl ester selected or the content of the (meth)acrylic acid alkyl ester based on the entire amount of monomer components constituting the acrylic polymer.

As regards the carboxyl group-containing monomer and hydroxyl group-containing monomer, for example, those described above as examples of the carboxyl group-containing monomer and the hydroxyl group-containing monomer both constituting the acrylic polymer (A) may be used. Above all, an acrylic acid is preferred as the carboxyl group-containing monomer, and 2-hydroxyethyl acrylate or 4-hydroxybutyl acrylate is preferred as the hydroxyl group-containing monomer.

As regards other ethylenically unsaturated monomers used as a copolymerization monomer, for example, those described above as examples of the other ethylenically unsaturated monomers in the acrylic polymer (A) may be used. Above all, vinyl acetate may be preferably used as the monomer component constituting the acrylic polymer (B).

The content of the (meth)acrylic acid alkyl ester having an alkyl group having a carbon number of 2 to 12 is preferably 50 wt % or more, more preferably 80 wt % or more, still more preferably 90 wt % or more, based on the entire amount of monomer components constituting the acrylic polymer (B). The upper limit of the content is not particularly limited but is preferably 99 wt % or less, more preferably 97 wt % or less. The (meth)acrylic acid alkyl ester having an alkyl group having a carbon number of 2 to 12 is a main monomer component assuming the pressure-sensitive adhesive characteristics or releasability of the acrylic polymer (B) and therefore, if the content is less than 50 wt %, the characteristics (such as pressure-sensitive adhesiveness and releasability) as an acrylic polymer may be hardly brought out.

Out of the monomer components constituting the acrylic polymer (B), from the standpoint of enhancing the adhesive force and balancing the hardness with the polarity, the content of the carboxyl group-containing monomer (particularly, an acrylic acid) is preferably from 1 to 15 parts by weight, more preferably from 1 to 10 parts by weight, still more preferably from 1 to 5 parts by weight, per 100 parts by weight of the (meth)acrylic acid alkyl ester having an alkyl group having a carbon number of 2 to 12. If the content of the carboxyl group-containing monomer is less than 1 part by weight, sufficient adhesive force may not be obtained, whereas if it exceeds 15 parts by weight, the characteristics may not be balanced.

Out of the monomer components constituting the acrylic polymer (B), from the standpoint of accelerating the crosslinking, the content of the hydroxyl group-containing monomer is preferably from 0.01 to 0.6 parts by weight, more preferably from 0.01 to 0.3 parts by weight, still more preferably from 0.01 to 0.2 parts by weight, per 100 parts by weight of the (meth)acrylic acid alkyl ester having an alkyl group having a carbon number of 2 to 12. If the content of the hydroxyl group-containing monomer is less than 0.01 parts by weight, the effect of accelerating the crosslinking may not be obtained, whereas if it exceeds 0.6 parts by weight, gelling proceeds rapidly and a problem may arise in the coatability.

As for the polymerization method of the acrylic polymer (B) and the polymerization initiator, chain transfer agent, emulsifier, solvent and the like used, those described above as examples in the acrylic polymer (A) may be employed.

As for the crosslinking agent used in the acrylic pressure-sensitive adhesive forming the layer B of the double-sided pressure-sensitive adhesive sheet of the present invention, those described above as examples of the crosslinking agent for use in the acrylic pressure-sensitive adhesive forming the layer A may be used. Above all, an isocyanate-based crosslinking agent is preferred. The content of the crosslinking agent (particularly, an isocyanate-based crosslinking agent) in the acrylic pressure-sensitive adhesive forming the layer B is preferably from 3 to 8 parts by weight, more preferably from 3 to 7 parts by weight, still more preferably from 3 to 6 parts by weight, per 100 parts by weight of the acrylic polymer (B). If the content of the crosslinking agent is less than 3 part by weight, the cohesive force is reduced and deterioration of releasability or adhesive residue may be caused, whereas if it exceeds 8 parts by weight, the gel fraction of the layer B becomes excessively high and the adhesive force may be reduced.

In the acrylic pressure-sensitive adhesive forming the layer B of the double-sided pressure-sensitive adhesive sheet of the present invention, from the standpoint of enhancing the pressure-sensitive adhesiveness, a tackifying resin is preferably added. As for the tackifying resin, those described above as examples of the tackifying resin for use in the acrylic pressure-sensitive adhesive forming the layer A may be used. Above all, a terpene phenolic resin (terpene phenolic tackifying resin) is preferred. The amount of the tackifying resin added is preferably from 1 to 60 parts by weight, more preferably from 30 to 50 parts by weight, per 100 parts by weight of the acrylic polymer (B). If the amount added is less than 1 part by weight, sufficient pressure-sensitive adhesive force may not be brought out, whereas if it exceeds 60 parts by weight, the adhesiveness may be deteriorated.

In addition to these components, the acrylic pressure-sensitive adhesive forming the layer B may contain, if desired, known additives such as antiaging agent, filler, colorant (e.g., pigment or dye), ultraviolet absorber, antioxidant, plasticizer, softener, surfactant and antistatic agent, within the range not impairing the characteristics of the present invention.

The method for forming the layer B in the double-sided pressure-sensitive adhesive sheet of the present invention is not particularly limited, and the same method as those for the layer A may be used.

The thickness of the layer B in the double-sided pressure-sensitive adhesive sheet of the present invention is not particularly limited but is preferably from 10 to 60 μm, more preferably from 15 to 55 μm, still more preferably from 20 to 50 μm. If the thickness of the layer B is less than 10 μm, the adhesive force may not be brought out, whereas if it exceeds 60 μm, the releasability may be deteriorated. Incidentally, the layer B may have either a single-layer construction or a multilayer construction.

The layer B in the double-sided pressure-sensitive adhesive sheet of the present invention has a gel fraction of 30 to 60% (wt %), preferably from 30 to 55%, still more preferably from 40 to 50%. If the gel fraction is less than 30%, the cohesive force of the layer B is reduced to readily cause a cohesion failure and, for example, deterioration of the adhesiveness or production of an adhesive residue at the separation disadvantageously occurs, whereas if it exceeds 60%, the layer B becomes hard to reduce the adhesiveness to an adherend and this is not preferred. The gel fraction above can be controlled, for example, by the monomer composition of the acrylic polymer (B) or the kind or content of the crosslinking agent.

The gel fraction of the layer B is preferably larger than the gel fraction of the layer A. If the gel fraction of the layer A is larger than that of layer B, the adhesive force to a rough surface may not be obtained.

The storage modulus (G′) at 23° C. of the layer B (resin for the layer B) in the double-sided pressure-sensitive adhesive sheet of the present invention is preferably from 1.0×10⁵ to 7.0×10⁵ Pa, more preferably from 1.1×10⁵ to 6.0×10⁵ Pa. If the storage modulus is less than 1.0×10⁵ Pa, the layer B becomes flexible and the releasability may be deteriorated, whereas if it exceeds 7.0×10⁵ Pa, the layer B becomes excessively hard and the adhesiveness is sometimes deteriorated. The storage modulus above can be controlled, for example, by the monomer composition of the acrylic polymer (B), the kind or content of the crosslinking agent, or the gel fraction.

The peak temperature of the loss tangent (tan δ) determined by the dynamic viscoelasticity measurement of the layer B (resin for the layer B) in the double-sided pressure-sensitive adhesive sheet of the present invention is, in view of releasability, preferably from −10 to 10° C., more preferably from −7 to 5° C. The peak temperature of tan δ can be controlled, for example, by the monomer composition of the acrylic polymer (B), the kind or content of the crosslinking agent, or the gel fraction.

The breaking elongation at 23° C. and 50% RH of the layer B (resin for the layer B) in the double-sided pressure-sensitive adhesive sheet of the present invention is preferably from 800 to 2,500%, more preferably from 800 to 2,000%, still more preferably from 1,000 to 1,800%. If the breaking elongation is less than 800%, the layer B becomes excessively hard and the adhesiveness may be deteriorated, whereas if it exceeds 2,500%, the layer B becomes flexible and the releasability is sometimes deteriorated. The breaking elongation can be controlled, for example, by the monomer composition of the acrylic polymer (B), the kind or content of the crosslinking agent, or the gel fraction.

### Release Liner

In view of protecting the pressure-sensitive adhesive surface or preventing blocking, the surface (pressure-sensitive adhesive surface) of the pressure-sensitive adhesive layer (each of the layer A and the layer B) of the double-sided pressure-sensitive adhesive sheet of the present invention is preferably protected by a release liner (separator) until usage. The release liner used is not particularly limited, and a known or conventional release sheet or the like may be used. Examples of the release liner which can be used include a substrate having a release layer, such as plastic film surface-treated with a release agent; a low adhesive substrate composed of a fluorine-based polymer such as polytetrafluoroethylene, polychlorotrifluoroethylene, polyvinyl fluoride, polyvinylidene fluoride, tetrafluoroethylene-hexafluoropropylene copolymer and chlorofluoroethylene-vinylidene fluoride copolymer; and a low adhesive substrate composed of a nonpolar polymer such as olefin-based resin (e.g., polyethylene and polypropylene).

The release liner may be provided on each pressure-sensitive adhesive surface, or after providing a release liner having a back release layer on one pressure-sensitive adhesive surface, the sheet may be wound to bring the back release layer of the separator into contact with the opposite pressure-sensitive adhesive surface.

### Double-Sided Pressure-Sensitive Adhesive Sheet

The thickness (thickness from the surface of the layer A to the surface of the layer B) of the double-sided pressure-sensitive adhesive sheet of the present invention is, in view of adhesiveness and processability, preferably from 100 to 270 μm, more preferably from 150 to 200 μm.

In the double-sided pressure-sensitive adhesive sheet of the present invention, (1) since a plastic film is used for the substrate, the sheet can be highly elastic and resistant to rupture as compared with a double-sided pressure-sensitive adhesive sheet using a nonwoven fabric substrate and even when used in a long or narrow form or used for a soft material such as foam, good workability for lamination or separation can be obtained. On the other hand, (2) since the plastic film substrate is not impregnated with a pressure-sensitive adhesive, the anchoring property of the pressure-sensitive adhesive layer to the substrate is lower than to a nonwoven fabric substrate and this gives rise to a problem that when releasing the double-sided pressure-sensitive adhesive sheet, separation occurs between the substrate and the pressure-sensitive adhesive layer and an adhesive residue is produced. In this regard, according to the present invention, a pressure-sensitive adhesive increased in the amount of the crosslinking agent (particularly, an isocyanate-based crosslinking agent) is used for the layer B and a polar functional group of the plastic film substrate is caused to react with the crosslinking agent, whereby the adhesiveness of the layer B to the plastic film substrate (particularly, a PET substrate) is enhanced and the adhesive residue is reduced. Furthermore, by controlling the amount of the crosslinking agent added, the gel fraction in the pressure-sensitive adhesive system is adjusted to a specific range, so that the releasability is enhanced while maintaining strong adhesiveness. As a result, “lifting” of the pressure-sensitive adhesive sheet is not caused even when laminated to a curved surface and a double-sided pressure-sensitive adhesive sheet assured of easy releasability and excellent recyclability is obtained. Furthermore, (3) the pressure-sensitive adhesive for the layer A is set to have a specific monomer composition and a specific gel fraction and as a relatively flexible resin, enhanced in the adhesiveness to a rough surface, so that the layer A can exert good adhesiveness particularly to a rough surface of a foam or the like.

The adhesive force (sometimes referred to as “normal-state pressure-sensitive adhesive force”) of the surface of the pressure-sensitive adhesive layer (each of the layer A and the layer B) of the double-sided pressure-sensitive adhesive sheet of the present invention to a stainless steel plate is, in view of adhesiveness to an adherend and releasability, preferably from 10 to 30 N/20 mm, more preferably from 15 to 25 N/20 mm. This adhesive force is a value obtained in accordance with JIS Z0237 by a 180° peel test (tensile speed: 300 mm/min). Incidentally, even when the adhesive force is in the range above, if a cohesion failure occurs, this is not preferred because the adhesion reliability decreases.

The adhesive force (sometimes referred to as “foam adhesive force”) of the surface of the layer A of the double-sided pressure-sensitive adhesive sheet of the present invention to a soft polyurethane foam (“Calmflex F2” produced by INOAC Corporation) is preferably 5 N/20 mm or more, more preferably 7 N/20 mm or more. This adhesive force is a value determined by a 180° peel test (tensile speed: 300 mm/min) of a sample obtained by laminating together the layer A of the double-sided pressure sensitive adhesive sheet and the foam under a 90% load (a load under which the foam is compressed to 90% from the initial thickness).

The double-sided pressure-sensitive adhesive sheet of the present invention is preferably used for usage (particularly, usage in fixing a foam) where a component or part composed of a foam or the like is laminated and fixed to an adherend by laminating the component or part such as foam to the layer A side (surface of the layer A) and laminating the adherend to the layer B side (surface of the layer B), because the surface of the layer A has excellent adhesiveness to a rough surface of a foam or the like and the surface of the layer B has strong adhesiveness and releasability. Furthermore, the double-sided pressure-sensitive adhesive sheet is preferably used when the component or part composed of a foam is released for recycling or the like (release usage). Above all, the sheet is preferably used when the component or part is long or narrow. Incidentally, the double-sided pressure-sensitive adhesive sheet of the present invention is not limited in its usage to the uses above but may also be used for usage in semipermanently fixing a component or part or an adherend.

The component or part composed of a foam is not particularly limited, but examples thereof include a buffer material and a dust-proof material (for example, made of a polyurethane foam). Also, examples of the adherend include an ink cartridge (for example, made of a mixed resin of polycarbonate and ABS, or made of polystyrene). A foam (component or part) and an adherend are laminated together through the double-sided pressure-sensitive adhesive sheet of the present invention, whereby a laminate of a foam and an adherend is obtained. Examples of the laminate include a printer cartridge and a liquid crystal display (LCD) panel of flat television.

### EXAMPLES

The present invention is described in greater detail below by referring to Examples, but the present invention is not limited to these Examples. In Table 1, the constituent monomer composition of the acrylic polymer and the blending amounts of crosslinking agent and tackifier in the pressure-sensitive adhesive forming the pressure-sensitive adhesive layer (each of the layer A and the layer B) of Examples and Comparative Examples, the breaking elongation and gel fraction of the pressure-sensitive adhesive layer (each of the layer A and the layer B), and the evaluation results of the obtained double-sided pressure-sensitive adhesive sheet are shown.

### Example 1

### (Acrylic Pressure-Sensitive Adhesive (A))

An acrylic polymer having a monomer composition composed of 70 parts by weight of butyl acrylate, 30 parts by weight of 2-ethylhexyl acrylate, 0.05 parts by weight of 4-hydroxybutyl acrylate and 3 parts by weight of acrylic acid was prepared. Then, Acrylic Pressure-Sensitive Adhesive (A) was prepared by blending 30 parts by weight of a polymerized rosin ester-based tackifier (“PENSEL D-125”, trade name, produced by Arakawa Chemical Industries, Ltd.) to 100 parts by weight of the acrylic polymer.

### (Acrylic Pressure-Sensitive Adhesive (B))

An acrylic polymer having a monomer composition composed of 100 parts by weight of butyl acrylate, 3 parts by weight of acrylic acid and 0. 1 parts by weight of 2-hydroxyethyl acrylate was prepared. Then, Acrylic Pressure-Sensitive Adhesive (B) was prepared by blending 40 parts by weight of a terpene phenolic tackifier (“SUMILITERESIN PR-12603”, trade name, produced by Sumitomo Bakelite Co., Ltd.) to 100 parts by weight of the acrylic polymer.

Acrylic Pressure-Sensitive Adhesive Solution (A1) was prepared by adding an isocyanate-based crosslinking agent (“Coronate L”, trade name, produced by Nippon Polyurethane Industry Co., Ltd.) and toluene to the Acrylic Pressure-Sensitive Adhesive (A) so that the resultant solution contained 2 parts by weight of the isocyanate-based crosslinking agent per 100 parts by weight of the acrylic polymer of the Acrylic Pressure-Sensitive Adhesive (A), followed by uniformly mixing the solution. The Acrylic Pressure-Sensitive Adhesive Solution (A1) was coated on one surface of a polyethylene terephthalate (PET) film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, for adhering to a foam).

Subsequently, Acrylic Pressure-Sensitive Adhesive Solution (B1) was prepared by adding an isocyanate-based crosslinking agent (“Coronate L”) and toluene to the Acrylic Pressure-Sensitive Adhesive (B) so that the resultant solution contained 4 parts by weight of the isocyanate-based crosslinking agent per 100 parts by weight of the acrylic polymer of the Acrylic Pressure-Sensitive Adhesive (B), followed by uniformly mixing the solution. The Acrylic Pressure-Sensitive Adhesive Solution (B1) was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) of the present invention was obtained.

### Example 2

An acrylic pressure-sensitive adhesive solution was prepared by adding an isocyanate-based crosslinking agent (“Coronate L”) and toluene to the Acrylic Pressure-Sensitive Adhesive (A) so that the resultant solution contained 3 parts by weight of the isocyanate-based crosslinking agent per 100 parts by weight of the acrylic polymer of the Acrylic Pressure-Sensitive Adhesive (A), followed by uniformly mixing the solution. This acrylic pressure-sensitive adhesive solution obtained was coated on one surface of a PET film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, or adhering to a foam).

Subsequently, an acrylic pressure-sensitive adhesive solution was prepared by adding an isocyanate-based crosslinking agent (“Coronate L”) and toluene to the Acrylic Pressure-Sensitive Adhesive (B) so that the resultant solution contained 6 parts by weight of the isocyanate-based crosslinking agent per 100 parts by weight of the acrylic polymer of the Acrylic Pressure-Sensitive Adhesive (B), followed by uniformly mixing the solution. This acrylic pressure-sensitive adhesive solution obtained was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) of the present invention was obtained.

### Example 3

An acrylic pressure-sensitive adhesive solution was prepared by adding an isocyanate-based crosslinking agent (“Coronate L”) and toluene to the Acrylic Pressure-Sensitive Adhesive (A) so that the resultant solution contained 4 parts by weight of the isocyanate-based crosslinking agent per 100 parts by weight of the acrylic polymer of the Acrylic Pressure-Sensitive Adhesive (A), followed by uniformly mixing the solution. This acrylic pressure-sensitive adhesive solution obtained was coated on one surface of a PET film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, for adhering to a foam).

Subsequently, an acrylic pressure-sensitive adhesive solution was prepared by adding an isocyanate-based crosslinking agent (“Coronate L”) and toluene to the Acrylic Pressure-Sensitive Adhesive (B) so that the resultant solution contained 3 parts by weight of the isocyanate-based crosslinking agent per 100 parts by weight of the acrylic polymer of the Acrylic Pressure-Sensitive Adhesive (B), followed by uniformly mixing the solution. This acrylic pressure-sensitive adhesive solution obtained was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) of the present invention was obtained.

### Comparative Example 1

An acrylic pressure-sensitive adhesive solution was prepared by adding an isocyanate-based crosslinking agent (“Coronate L”) and toluene to the Acrylic Pressure-Sensitive Adhesive (A) so that the resultant solution contained 6 parts by weight of the isocyanate-based crosslinking agent per 100 parts by weight of the acrylic polymer of the Acrylic Pressure-Sensitive Adhesive (A), followed by uniformly mixing the solution. This acrylic pressure-sensitive adhesive solution obtained was coated on one surface of a PET film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, for adhering to a foam).

Subsequently, an acrylic pressure-sensitive adhesive solution was prepared by adding an isocyanate-based crosslinking agent (“Coronate L”) and toluene to the Acrylic Pressure-Sensitive Adhesive (B) so that the resultant solution contained 2 parts by weight of the isocyanate-based crosslinking agent per 100 parts by weight of the acrylic polymer of the Acrylic Pressure-Sensitive Adhesive (B), followed by uniformly mixing the solution. This acrylic pressure-sensitive adhesive solution obtained was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) of the present invention was obtained.

### Comparative Example 2

An acrylic pressure-sensitive adhesive solution was prepared by adding an isocyanate-based crosslinking agent (“Coronate L”) and toluene to the Acrylic Pressure-Sensitive Adhesive (A) so that the resultant solution contained 0.5 parts by weight of the isocyanate-based crosslinking agent per 100 parts by weight of the acrylic polymer of the Acrylic Pressure-Sensitive Adhesive (A), followed by uniformly mixing the solution. This acrylic pressure-sensitive adhesive solution obtained was coated on one surface of a PET film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, for adhering to a foam).

Subsequently, an acrylic pressure-sensitive adhesive solution was prepared by adding an isocyanate-based crosslinking agent (“Coronate L”) and toluene to the Acrylic Pressure-Sensitive Adhesive (B) so that the resultant solution contained 9 parts by weight of the isocyanate-based crosslinking agent per 100 parts by weight of the acrylic polymer of the Acrylic Pressure-Sensitive Adhesive (B), followed by uniformly mixing the solution. This acrylic pressure-sensitive adhesive solution obtained was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) of the present invention was obtained.

### Comparative Example 3

The Acrylic Pressure-Sensitive Adhesive Solution (A1) of Example 1 was coated on one surface of a PET film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, for adhering to a foam).

Subsequently, the Acrylic Pressure-Sensitive Adhesive Solution (A1) of Example 1 was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) was obtained.

### Comparative Example 4

The Acrylic Pressure-Sensitive Adhesive Solution (B1) of Example 1 was coated on one surface of a PET film substrate (“Lumirror S-27”, produced by Toray Industries, Inc., thickness: 75 μm) to have a thickness of 70 μm after drying and dried at 100° C. for 2 minutes to form a pressure-sensitive adhesive layer (layer A, which is to be adhered to a foam).

Subsequently, the Acrylic Pressure-Sensitive Adhesive Solution (B1) of Example 1 was coated on the surface of the PET film substrate opposite to the surface on which the layer A was adhered to have a thickness of 40 μm after drying and dried at 100° C. for 2 minutes to form a pressure-sensitive adhesive layer (layer B, for releasing). In this way, a double-sided pressure-sensitive adhesive sheet (thickness: 185 μm) was obtained.

### (Evaluation)

The double-sided pressure-sensitive adhesive sheets obtained in Examples and Comparative Examples were measured or evaluated by the following measuring methods or evaluation methods. The measurement or evaluation results are shown in Table 1.

### (1) Adhesive Force (180° Peel, to Stainless Steel Plate) (Normal-State Pressure-Sensitive Adhesive Force)

A sheet in a strip form of 20 mm in width and 90 mm in length was cut out from each of the double-sided pressure-sensitive adhesive sheets obtained in Examples and Comparative Examples, and a PET film of 25 μm in thickness was laminated (lined) to the pressure-sensitive adhesive surface opposite the measuring surface to produce a measurement sample.

A 180° peel test was performed in accordance with JIS Z0237. The measurement sample and a test plate (SUS304BA steel plate) were laminated together by passing a 2-kg rubber roller (width: 30 mm) back and force once over the sheet in a normal state (23° C., 50% RH). After a lapse of 30 minutes, the measurement sample (pressure-sensitive adhesive sheet) was separated using a tensile tester, and the load at the separation was measured and defined as an adhesive force (180° peel, to stainless steel plate) (normal-state pressure-sensitive adhesive force).

The measurement was performed in an atmosphere of 23° C. and 50% RH under the conditions of a peel angle of 180°, a tensile speed of 300 mm/min and a peel distance of 60 mm. The number of tests was 3 (on average) for each sample. Also, the measurement was performed on both pressure-sensitive adhesive surfaces of the double-sided pressure-sensitive adhesive sheet.

### (2) Adhesive Force (180° Peel, to Foam) (Foam Adhesive Force)

A sheet in a strip form of 20 mm in width and 90 mm in length was cut out from each of the double-sided pressure-sensitive adhesive sheets obtained in Examples and Comparative Examples, and a PET film of 25 μm in thickness was laminated (lined) to the pressure-sensitive adhesive surface opposite the measuring surface to produce a measurement sample.

The measurement sample and a soft polyurethane foam (“Calmflex F2” produced by INOAC Corporation) fixed to a 5 mm-thick aluminum plate with a double-sided adhesive tape were laminated together by passing a 2-kg rubber roller (width: 30 mm) back and force once over the sheet. The laminating operation was performed using a jig under a 90% load (to compress the foam to 90%).

After a lapse of 30 minutes, the measurement sample (pressure-sensitive adhesive sheet) was separated using a tensile tester, and the load at the separation was measured. The measurement was performed in an atmosphere of 23° C. and 50% RH under the conditions of a peel angle of 180°, a tensile speed of 300 mm/min and a peel distance of 60 mm. The number of tests was 3 (on average) for each sample. Also, the measurement was performed on only the pressure-sensitive adhesive surface for adhering to a foam.

The maximum and minimum average values of the load were determined from the chart of peel distance−load (peel load) at the separation obtained in the peel measurement above, and the average value of these maximum and minimum average values {=(maximum average value+minimum average value)/2}was defined as an adhesive force (180° peel, to foam) (foam adhesive force).

The maximum average value is an average value obtained by averaging all values of load at crests of ridge portions in the obtained releasing chart, and the minimum average value is an average value obtained by averaging all values of load at crests of trough portions in the obtained releasing chart. In the calculation above, a portion excluding 10% after the start of peeling and 10% before the completion of pealing in the releasing chart was used.

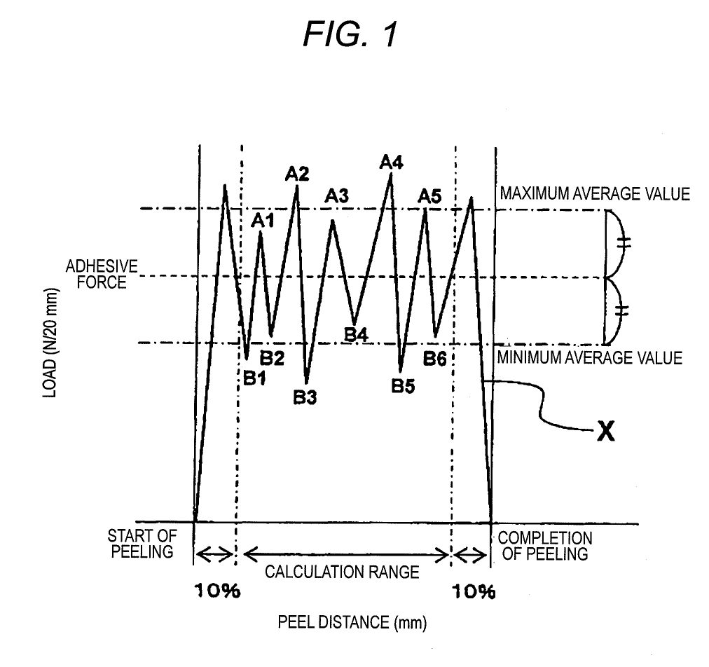

More specifically, for example, as shown in FIG. 1, out of the portions used for calculation of the obtained releasing chart (X), the average value obtained by averaging the values of load at crests A1, A2, . . . A5 of the ridge portions is defined as the maximum average value, and the average value obtained by averaging the values of load at crests B1, B2, . . . B6 of the trough portions is defined as the minimum average value.

### (3) Releasability

A sheet in a strip form of 20 mm in width and 90 mm in length was cut out from each of the double-sided pressure-sensitive adhesive sheets obtained in Examples and Comparative Examples, and a PET film of 25 μm in thickness was laminated (lined) to the pressure-sensitive adhesive surface opposite the measuring surface to produce a measurement sample.

The measurement sample and a polycarbonate plate were laminated together by passing a 2-kg rubber roller (width: 30 mm) back and force once over the sheet. After the resulting laminate was left standing for 2 weeks under the conditions of 70° C. (no humidity control) or 60° C. and 90% RH, the measurement sample (pressure-sensitive adhesive sheet) was separated using a tensile tester at a peel angle of 180° and a tensile speed 300 mm/min, and the adhesive residue on the polycarbonate plate surface was evaluated with an eye and judged according to the following criteria.

Incidentally, the measurement was performed on only the pressure-sensitive adhesive surface for releasing.

A: An adhesive residue was not observed.

B: An adhesive residue was observed in less than 30% of the lamination area.

C: An adhesive residue was observed in 30% or more of the lamination area.

The releasability is insufficient in both B and C.

TABLE 1

| | | | Example 1 | | Example 2 | | Example 3 | |
|---|---|---|---|---|---|---|---|---|
| | | | Layer A | Layer B | Layer A | Layer B | Layer A | Layer B |
| Acrylic polymer | Monomer composition (parts by weight) | Butyl acrylate | 70 | 100 | 70 | 100 | 70 | 100 |
| | | 2-Ethylhexyl acrylate | 30 | | 30 | | 30 | |
| | | 2-Hydroxy ethyl acrylate | | 0.1 | | 0.1 | | 0.1 |
| | | 4-Hydroxy butyl acrylate | 0.05 | | 0.05 | | 0.05 | |
| | | Acrylic acid | 3 | 3 | 3 | 3 | 3 | 3 |
| Crosslinking | Blending amount per 100 parts by weight | Coronate L | 2 | 4 | 3 | 6 | 4 | 3 |
| agent | of acrylic polymer (parts by weight) | | | | | | | |
| Tackifier | Blending amount per 100 parts by weight | PENSEL D125 | 30 | | 30 | | 30 | |
| | of acrylic polymer (parts by weight) | SUMILITERESIN PR-12603 | | 40 | | 40 | | 40 |

| Breaking elongation (%) | | 2700 | 1300 | 2500 | 810 | 2300 | 2400 |
|---|---|---|---|---|---|---|---|
| Gel fraction (%) | | 24 | 48 | 34 | 56 | 37 | 42 |
| Layer A | Normal-state pressure-sensitive adhesive force | 20.5 | — | 20.0 | — | 19.8 | — |
| | (180° peel, to stainless steel plate) (N/20 mm) | | | | | | |
| | Foam adhesive force (180° peel, to foam) (N/20 mm) | 8.5 | — | 8.3 | — | 7.5 | — |
| Layer B | Normal-state pressure-sensitive adhesive force | — | 19.0 | — | 18.2 | — | 19.3 |
| | (180° peel, to stainless steel plate) (N/20 mm) | | | | | | |
| | Releasability (after storage at 60° C./90% RH) | — | A | — | A | — | A |
| | Releasability (after storage at 70° C.) | — | A | — | A | — | A |

| | | | Comparative | | Comparative | | Comparative | | Comparative | |
|---|---|---|---|---|---|---|---|---|---|---|
| | | | Example 1 | | Example 2 | | Example 3 | | Example 4 | |
| | | | Layer A | Layer B | Layer A | Layer B | Layer A | Layer B | Layer A | Layer B |
| Acrylic | Monomer composition | Butyl acrylate | 70 | 100 | 70 | 100 | 70 | 70 | 100 | 100 |
| polymer | (parts by weight) | 2-Ethylhexyl acrylate | 30 | | 30 | | 30 | 30 | | |
| | | 2-Hydroxy ethyl | | 0.1 | | 0.1 | | | 0.1 | 0.1 |
| | | acrylate | | | | | | | | |
| | | 4-Hydroxy butyl | 0.05 | | 0.05 | | 0.05 | 0.05 | | |
| | | acrylate | | | | | | | | |
| | | Acrylic acid | 3 | 3 | 3 | 3 | 3 | 3 | 3 | 3 |
| Crosslinking | Blending amount per 100 parts by | Coronate L | 6 | 2 | 0.5 | 9 | 2 | 2 | 4 | 4 |
| agent | weight of acrylic polymer | | | | | | | | | |
| | (parts by weight) | | | | | | | | | |
| Tackifier | Blending amount per 100 parts by | PENSEL D125 | 30 | | 30 | | 30 | 30 | | |
| | weight of acrylic polymer | SUMILITERESIN | | 40 | | 40 | | | 40 | 40 |
| | (parts by weight) | PR-12603 | | | | | | | | |

| Breaking elongation (%) | | 1600 | 3400 | 5000 | 540 | 2700 | 2700 | 1300 | 1300 |
|---|---|---|---|---|---|---|---|---|---|
| Gel fraction (%) | | 45 | 26 | 4 | 72 | 24 | 24 | 48 | 48 |
| Layer A | Normal-state pressure-sensitive adhesive force | 19.0 | — | 23.0 | — | 20.5 | — | 19.8 | — |
| | (180° peel, to stainless steel plate) (N/20 mm) | | | (*1) | | | | | |
| | Foam adhesive force (180° peel, to foam) (N/20 mm) | 1.3 | — | 8.4 | — | 8.5 | — | 0.8 | — |
| Layer B | Normal-state pressure-sensitive adhesive force | — | 19.5 | — | 14.5 | — | 18.9 | — | 19.0 |
| | (180° peel, to stainless steel plate) (N/20 mm) | | | | | | | | |
| | Releasability (after storage at 60° C./90% RH) | — | C | — | A | — | C | — | A |
| | Releasability (after storage at 70° C.) | — | C | — | A | — | C | — | A |

(*1) Cohesion failure

It is seen from the evaluation results (Table 1) that the double-sided pressure-sensitive adhesive sheet of the present invention (Examples) exhibits good adhesive force to both a stainless steel plate and a foam and at the same time, ensures excellent releasability without adhesive residue when releasing the sheet.

On the other hand, in the case where the gel fraction of the layer A is high or a (meth)acrylic acid alkyl ester having an alkyl group having a carbon number of 7 to 12 was not used as a constituent monomer of the pressure-sensitive adhesive forming the layer A (Comparative Examples 1 and 4), the adhesiveness to a foam was reduced. Also, in the case where the gel fraction of the layer A was low (Comparative Example 2), the layer A caused a cohesion failure and the adhesiveness (adhesion reliability) was reduced. Furthermore, the releasability was reduced when the gel fraction of the layer B was low (Comparative Examples 1 and 3), and the adhesiveness (adhesive force) of the layer B was reduced when the gel fraction of the layer B was high (Comparative Example 2).

While the present invention has been described in detail and with reference to specific embodiments thereof, it will be apparent to one skilled in the art that various changes and modifications can be made therein without departing from the scope thereof

This application is based on Japanese patent application No. 2008-200621 filed on Aug. 4, 2008, the entire contents thereof being hereby incorporated by reference.

Further, all references cited herein are incorporated in their entireties.

What is claimed is:

1. A double-sided pressure-sensitive adhesive sheet comprising:
a plastic film substrate;
a pressure-sensitive adhesive layer A provided on one side of said substrate; and
a pressure-sensitive adhesive layer B provided on the other side of said substrate,
wherein the pressure-sensitive adhesive layer A is formed from an acrylic pressure-sensitive adhesive containing a crosslinking agent and a (meth)acrylic polymer composed of, as essential monomer components, a (meth)acrylic acid alkyl ester having an alkyl group having a carbon number of 2 to 6, a (meth)acrylic acid alkyl ester having an alkyl group having a carbon number of 7 to 12, a carboxyl group-containing monomer and a hydroxyl group-containing monomer, said layer A having a gel fraction of 5 to 40%, and
the pressure-sensitive adhesive layer B is formed from an acrylic pressure-sensitive adhesive containing a crosslinking agent and a (meth)acrylic polymer composed of, as essential monomer components, a (meth)acrylic acid alkyl ester having an alkyl group having a carbon number of 2 to 12, a carboxyl group-containing monomer and a hydroxyl group-containing monomer, said layer B having a gel fraction of 30 to 60%.

2. The double-sided pressure-sensitive adhesive sheet according to claim 1, wherein in the acrylic pressure-sensitive adhesive forming said layer A, the total content of the (meth)acrylic acid alkyl ester having an alkyl group having a carbon number of 2 to 6 and the (meth)acrylic acid alkyl ester having an alkyl group having a carbon number of 7 to 12 is from 50 to 99 wt % based on all monomer components constituting the (meth)acrylic polymer, and
the content ratio between the (meth)acrylic acid alkyl ester having an alkyl group having a carbon number of 2 to 6 and the (meth)acrylic acid alkyl ester having an alkyl group having a carbon number of 7 to 12 is from 5/95 to 95/5 (by weight).

3. The double-sided pressure-sensitive adhesive sheet according to claim 1, wherein the acrylic pressure-sensitive adhesive forming said layer A contains from 1 to 5 parts by weight of an isocyanate-based crosslinking agent per 100 parts by weight of the (meth)acrylic polymer.

4. The double-sided pressure-sensitive adhesive sheet according to claim 1, wherein in the acrylic pressure-sensitive adhesive forming said layer B, the content of the (meth)acrylic acid alkyl ester having an alkyl group having a carbon number of 2 to 12 is from 50 to 99 wt % based on all monomer components constituting the (meth)acrylic polymer.

5. The double-sided pressure-sensitive adhesive sheet according to claim 1, wherein the acrylic pressure-sensitive adhesive forming said layer B contains from 3 to 8 parts by weight of an isocyanate-based crosslinking agent per 100 parts by weight of the (meth)acrylic polymer.

6. The double-sided pressure-sensitive adhesive sheet according to claim 1, wherein said layer A has a storage modulus at 23° C. of from 0.1×10⁵ to 1.0×10⁵ Pa and said layer B has a storage modulus at 23° C. of from 1.0×10⁵ to 7.0×10⁵ Pa, as measured by a dynamic viscoelasticity test.

7. The double-sided pressure-sensitive adhesive sheet according to claim 1, wherein said layer A has a breaking elongation of from 2,000 to 4,000% and said layer B has a breaking elongation of from 800 to 2,500%, as measured by a tensile test (23° C., 50% RH).

8. The double-sided pressure-sensitive adhesive sheet according to claim 1, wherein the acrylic pressure-sensitive adhesive forming said layer A further contains 1 to 60 parts by weight of a rosin-based tackifying resin per 100 parts by weight of the (meth)acrylic polymer.

9. The double-sided pressure-sensitive adhesive sheet according to claim 1, wherein the acrylic pressure-sensitive adhesive forming said layer B further contains 1 to 60 parts by weight of a terpene phenolic tackifying resin per 100 parts by weight of the (meth)acrylic polymer.

10. The double-sided pressure-sensitive adhesive sheet according to claim 1, wherein the gel fraction of said layer B is larger than the gel fraction of said layer A.

11. The double-sided pressure-sensitive adhesive sheet according to claim 1, which is a double-sided pressure-sensitive adhesive sheet used for fixing a foam to an adherend and is releasable from the adherend.

12. A method of fixing a foam, said method comprising laminating a foam to the pressure-sensitive adhesive surface of said layer A of the double-sided pressure-sensitive adhesive sheet according to claim 1 and laminating an adherend to the pressure-sensitive adhesive surface of said layer B of the double-sided pressure-sensitive adhesive sheet.

13. A laminate obtained by laminating together a foam and an adherend through the double-sided pressure-sensitive adhesive sheet according to claim 1.
